(19) United States
(12) Patent Application Publication
(10) Pub. No.: US 2022/0009062 A1
(43) Pub. Date: Jan. 13, 2022

(54) Angle Adjustment Structure for Pressing Hand Tool

(71) Applicant: Te-Chuan Yang, Taichung City (TW)

(72) Inventor: Te-Chuan Yang, Taichung City (TW)

(21) Appl. No.: 16/925,607

(22) Filed: Jul. 10, 2020

(51) Int. Cl. B25B 23/00; B25B 23/16

(52) U.S. Cl. CPC B25B 23/0028; B25B 23/16

(57) ABSTRACT

An angle adjustment structure for pressing a hand tool contains: a first handle, a second handle, a spring washer, a return spring, two pressers, and two fasteners. The first hand includes a contact sheet having a first thickness, a first toothed orifice, and a positioning portion. The second handle includes a groove having a second thickness, two fixing plates, a second toothed orifice, and a trench. A profile of the second toothed orifice is identical to a profile of the first toothed orifice. The return spring is defined the two pressers. A respective presser includes a pressing portion, a slot, a notch, a toothed column, and a fixing portion. A respective fastener is engaged between the second handle and the respective presser to limit the respective presser to operate among the second toothed orifice, the trench, the recess, and the first toothed orifice.

### BACKGROUND OF THE INVENTION

### Field of the Invention

The present invention relates to a hand tool, and more particularly to an angle adjustment structure for pressing the hand tool to adjust an angle between a first handle and a second handle, and the first handle and the second handle are fixed to rotate a workpiece after adjusting the angle.

### Description of the Prior Art

A conventional hand tool, such as a wrench, is used widely in different spaces. The hand tool has a fixed shape and length, so it is inconvenient to apply the hand tool in an angled space. To overcome this problem, the hand tool has two handles connected so that the two handles are rotated to adjust an angle between the two handles. However, the handles are driven to rotate by a single drive element, such as a switch, and the switch is pressed or rotated to release a limitation of the two handles, thus rotating the two handles.

However, when operating the hand tool and shifting the switch accidentally, the two handles are released to stop a desired operation of the hand tool or to cause using danger.

The present invention has arisen to mitigate and/or obviate the afore-described disadvantages.

### SUMMARY OF THE INVENTION

The primary object of the present invention is to provide an angle adjustment structure for pressing a hand tool which when rotating a first handle and a second handle to adjust an angle between the first handle and the second handle, the two pressers beside the second handle have to be pressed simultaneously. In other words, when one of the two pressers is pressed merely, the first handle and the second handle are not rotated to adjust the angle so as to avoid a rotation of the first handle and the second handle in case pressing the one presser only, thus obtaining using safety.

To provide above-mentioned objects, an angle adjustment structure for pressing a hand tool provided by the present invention contains: a first handle, a second handle, a spring washer, a return spring, two pressers, and two fasteners.

The first hand includes a contact sheet formed on a first end thereof and having a first thickness, a first toothed orifice passing through the contact sheet, and the first toothed orifice has multiple teeth arranged around an inner wall thereof equidistantly.

The second handle includes a groove defined on a first end thereof and having a second thickness, and the second thickness is greater than the first thickness, the second handle includes two fixing plates extending from a top and a bottom of the groove, and the second handle includes a second toothed orifice formed adjacent to the groove. A profile of the second toothed orifice is identical to a profile of the first toothed orifice.

The return spring is defined the two pressers.

A respective presser includes a pressing portion formed on an outer wall thereof, a slot defined outside the pressing portion, and a notch and a toothed column which are arranged inside the slot. The toothed column contacts with the second toothed orifice and the first toothed orifice, and the respective presser includes a fixing portion, a respective fastener is received in a recess.

The contact sheet of the first handle is engaged into the groove of the second handle, the first toothed orifice is aligned with the second toothed orifice, and two toothed columns of the two pressers are retained into the first toothed orifice via the second toothed orifice. The return spring is defined between the two pressers and is fixed by the two fixing portions of the two pressers, and the two pressers are pushed outward by the return spring. When the respective fastener is in the recess, the two pressers are pressed. When releasing the two pressers, the two pressers are pushed outward by the return spring and are fixed by the two fasteners to avoid a removal so that the two pressers are pressed and moved back to two original positions within a determined moving range.

### BRIEF DESCRIPTION OF THE DRAWINGS

FIG. 1 is a perspective view showing the assembly of an angle adjustment structure for pressing a hand tool according to a preferred embodiment of the present invention.

FIG. 2 is a perspective view showing the exploded components of the angle adjustment structure for pressing the hand tool according to the preferred embodiment of the present invention.

FIG. 3 is a cross sectional view showing the exploded components of the angle adjustment structure for pressing the hand tool according to the preferred embodiment of the present invention.

FIG. 4 is a cross sectional view showing the operation of the angle adjustment structure for pressing the hand tool according to the preferred embodiment of the present invention.

FIG. 5 is another cross sectional view showing the operation of the angle adjustment structure for pressing the hand tool according to the preferred embodiment of the present invention.

FIG. 6 is a side plan view showing the operation of the angle adjustment structure for pressing the hand tool according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

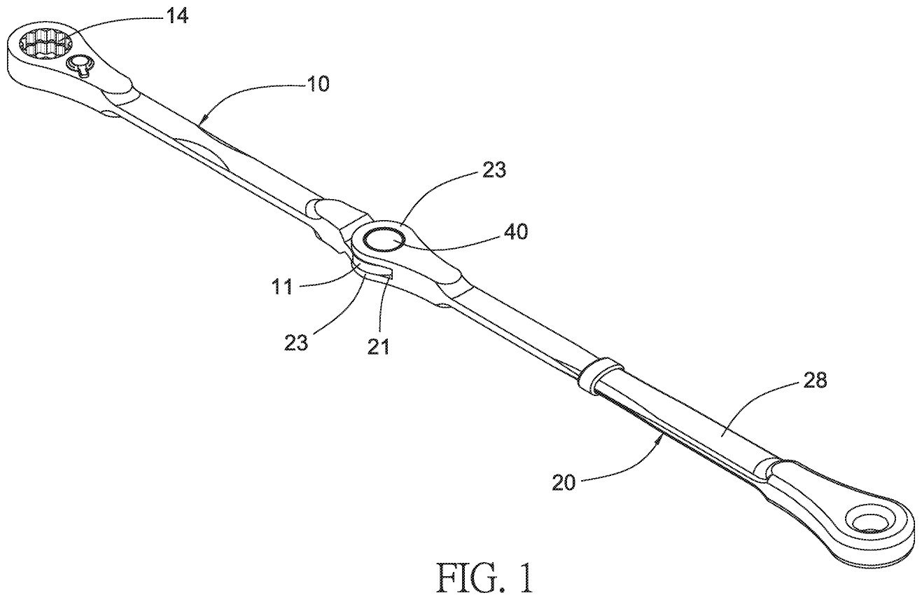

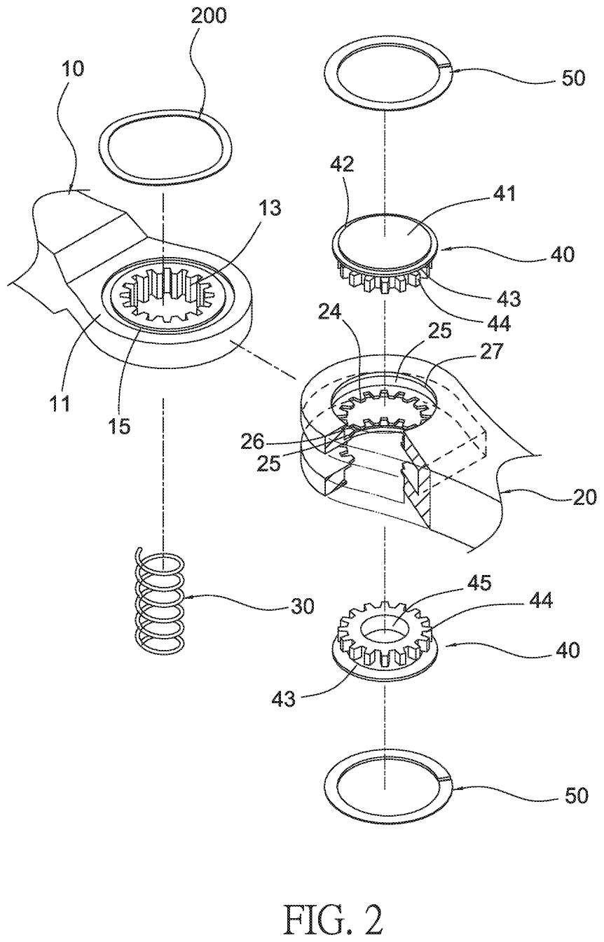

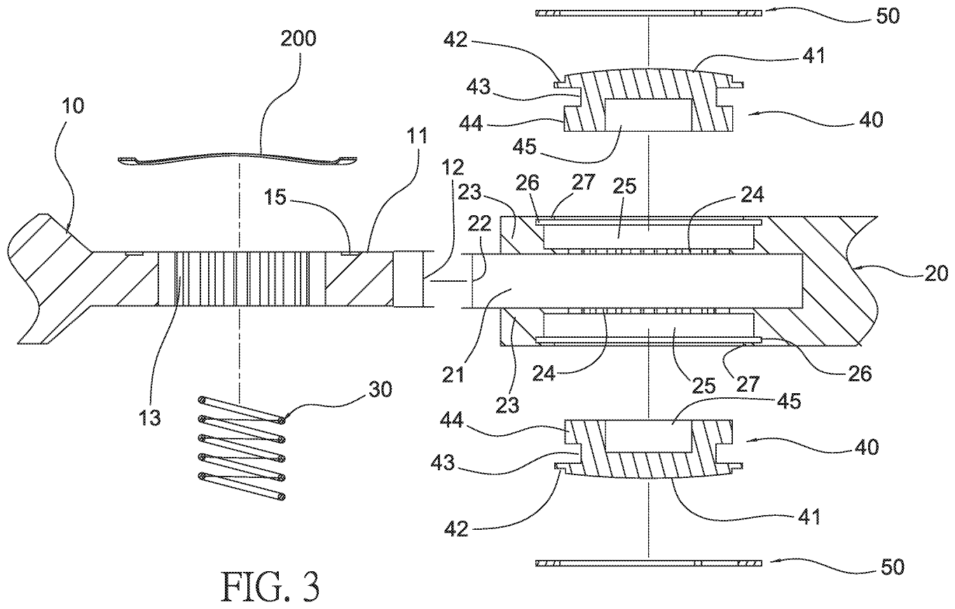

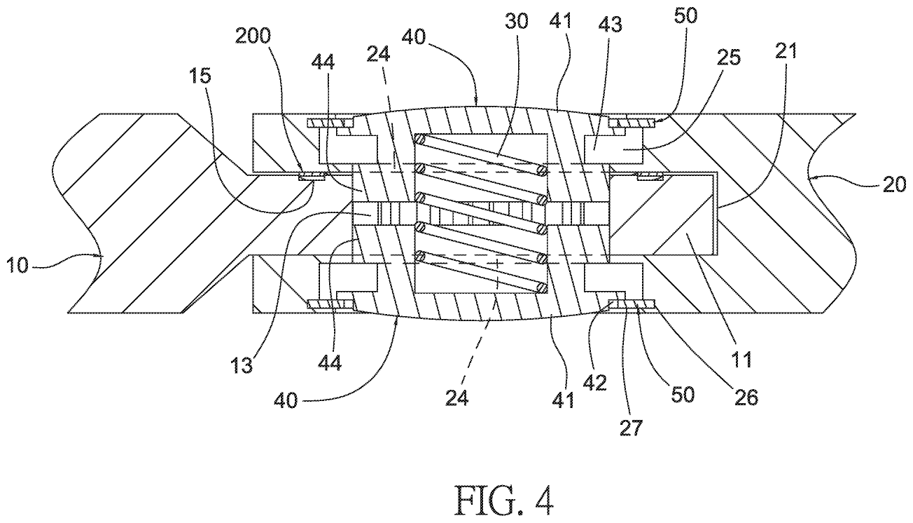

With reference to FIGS. 1 to 4, an angle adjustment structure for pressing a hand tool according to a preferred embodiment of the present invention comprises: a first handle 10, a second handle 20, a spring washer 200, a return spring 30, two pressers 40, and two fasteners 50.

The first hand 10 includes a contact sheet 11 formed on a first end thereof and having a first thickness 12, a first toothed orifice 13 passing through the contact sheet 11, wherein the first toothed orifice 13 has multiple teeth arranged around an inner wall thereof equidistantly, a receiving orifice 14 defined on a second end of the first handle 10 and configured to fit with a screw or a nut, and a positioning portion 15 formed on the inner wall of the first toothed orifice 13 of the contact sheet 11 of the first handle 10, wherein the positioning portion 15 is configured to receive the spring washer 200.

The second handle 20 includes a groove 21 defined on a first end thereof and having a second thickness 22, wherein the second thickness 22 is greater than the first thickness 12, two fixing plates 23 extending from a top and a bottom of the groove 21, a second toothed orifice 24 formed adjacent to the groove 21, a trench 25 defined on an outer wall of the second toothed orifice 24, and a recess 26 and a limiting fringe 27 which are formed on an outer wall of the trench 25, wherein a profile of the second toothed orifice 24 is identical to a profile of the first toothed orifice 13, and the second handle 20 further includes a grip portion 28 formed on a second end thereof and configured to be gripped by a user.

A respective presser 40 includes a pressing portion 41 formed on an outer wall thereof, a slot 42 defined outside the pressing portion 41, and a notch 43 and a toothed column 44 which are arranged inside the slot 42, wherein the toothed column 44 contacts with the second toothed orifice 24 and the first toothed orifice 13, and the respective presser 40 includes a fixing portion 45 arranged on an inner wall thereof.

The return spring 30 is defined between two fixing portions 45 of the two pressers 40.

A respective fastener 50 is engaged between the recess 26 of the second handle 20 and the slot 42 of the respective presser 40 to limit the respective presser 40 to operate among the second toothed orifice 24, the trench 25, the recess 26, and the first toothed orifice 13.

The contact sheet 11 of the first handle 10 is engaged into the groove 21 of the second handle 20, and the spring washer 200 is defined between the contact sheet 11 and one of the two fixing plates 23 and is fixed by the positioning portion 15. The first toothed orifice 13 is aligned with the second toothed orifice 24, and the two toothed columns 44 of the two pressers 40 are retained into the first toothed orifice 13 via the second toothed orifice 24. The return spring 30 is defined between the two pressers 40 and is fixed by the two fixing portions 45 of the two pressers 40, and the two pressers 40 are pushed outward by the return spring 30, when the respective fastener 50 is fixed between the slot 42 and the recess 26, the two pressers 40 are pressed. When releasing the two pressers 40, the two pressers 40 are pushed outward by the return spring 30 and are fixed by the two fasteners 50 to avoid a removal so that the two pressers 40 are pressed and moved back to two original positions within a determined moving range.

When the two pressers 40 are not pressed and are pushed outward by the return spring 30, two toothed columns 43 are located between the second toothed orifice 24 and the first toothed orifice 13, hence the two toothed columns 43 connect with the second toothed orifice 24 and the first toothed orifice 13 so that the first handle 10 and the second handle 20 are connected and actuated.

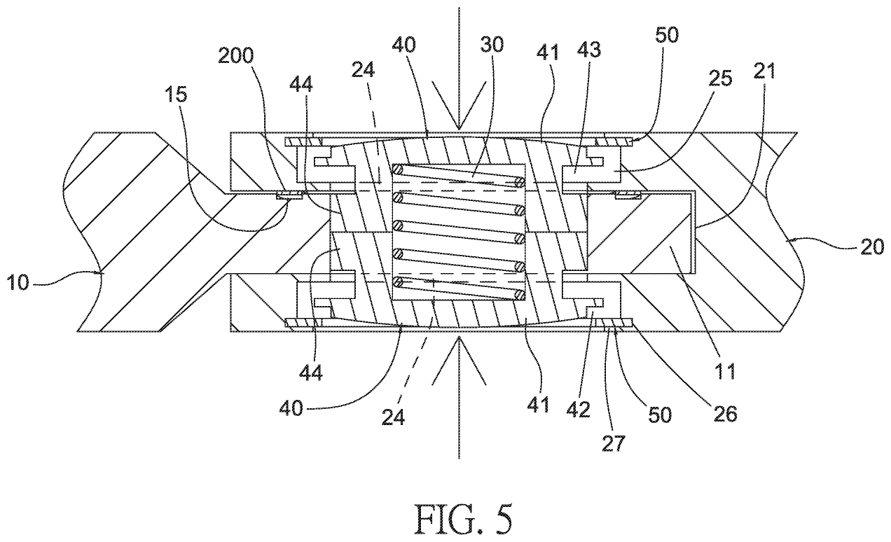

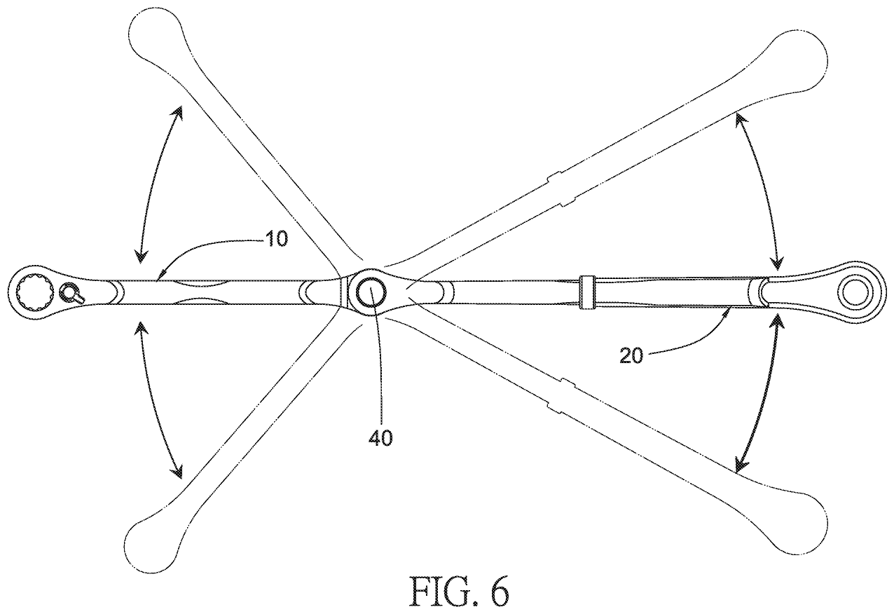

When the two pressers 40 are pressed simultaneously, as shown in FIGS. 5 and 6, the two toothed columns 43 remove from the second toothed orifice 24 so that the first handle 10 and the second handle 20 are not connected and actuated, and the first handle 10 and the second handle 20 are rotated to adjust an angle between the first handle 10 and the second handle 20, then the two pressers 40 are released to be pushed outward by the return spring 30, and the two toothed columns 43 are engaged between the second toothed orifice 24 and the first toothed orifice 13 so that the first handle 10 and the second handle 20 are connected and actuated, thus rotating the handle tool.

The two pressers 40 are controlled by the return spring 30, so when the one presser 40 is pressed merely, the other presser 40 is configured to fix the first handle 10 and the second handle 20 to avoid a rotation of the first handle 10 and the second handle 20.

Accordingly, when rotating the first handle 10 and the second handle 20 to adjust the angle between the first handle 10 and the second handle 20, the two pressers 40 beside the second handle 20 are pressed simultaneously. In other words, when the one presser 40 is pressed merely, the first handle 10 and the second handle 20 are not rotated to adjust the angle so as to avoid a rotation of the first handle and the second handle 20 in case pressing the one presser 40 only, thus obtaining using safety.

While various embodiments in accordance with the present invention have been shown and described, it is clear to those skilled in the art that further embodiments may be made without departing from the scope of the present invention.

What is claimed is:

1. An angle adjustment structure for pressing a hand tool comprising: a first handle, a second handle, a spring washer, a return spring, two pressers, and two fasteners;
wherein the first hand includes a contact sheet formed on a first end thereof and having a first thickness, a first toothed orifice passing through the contact sheet, wherein the first toothed orifice has multiple teeth arranged around an inner wall thereof equidistantly, and a positioning portion formed on the inner wall of the first toothed orifice of the contact sheet of the first handle, wherein the positioning portion is configured to receive the spring washer;
wherein the second handle includes a groove defined on a first end thereof and having a second thickness, wherein the second thickness is greater than the first thickness, the second handle includes two fixing plates extending from a top and a bottom of the groove, and the second handle includes a second toothed orifice formed adjacent to the groove, wherein a profile of the second toothed orifice is identical to a profile of the first toothed orifice, and the second handle further includes a trench defined on an outer wall of the second toothed orifice;
wherein the return spring is defined the two pressers;
wherein a respective presser includes a pressing portion formed on an outer wall thereof, a slot defined outside the pressing portion, and a notch and a toothed column which are arranged inside the slot, wherein the toothed column contacts with the second toothed orifice and the first toothed orifice, and the respective presser includes a fixing portion;
wherein a respective fastener is engaged between the second handle and the respective presser to limit the respective presser to operate among the second toothed orifice, the trench, the recess, and the first toothed orifice;
wherein the contact sheet of the first handle is engaged into the groove of the second handle, and the spring washer is defined between the contact sheet and one of the two fixing plates and is fixed by the positioning portion, the first toothed orifice is aligned with the second toothed orifice, and two toothed columns of the two pressers are retained into the first toothed orifice via the second toothed orifice, wherein the return spring is defined between the two pressers and is fixed by the two fixing portions of the two pressers, and the two pressers are pushed outward by the return spring, when the respective fastener is fixed between the slot and the recess, the two pressers are pressed, and when releasing the two pressers, the two pressers are pushed outward by the return spring and are fixed by the two fasteners to avoid a removal.

2. The angle adjustment structure as claimed in claim 1, wherein the first handle includes a receiving orifice defined on a second end thereof.

3. The angle adjustment structure as claimed in claim 1, wherein the second handle further includes a grip portion formed on a second end thereof.

4. The angle adjustment structure as claimed in claim 1, wherein the trench of the second handle has a recess and a limiting fringe which are formed on an outer wall of the trench, and the respective fastener is fixed in the recess and the trench.

5. The angle adjustment structure as claimed in claim 1, wherein the respective presser includes a fixing portion arranged on an inner wall thereof, and the return spring is defined between the two pressers and is fixed by two fixing portions of the two pressers.

6. The angle adjustment structure as claimed in claim 1, wherein when the two pressers are not pressed and are pushed outward by the return spring, the two toothed columns are located between the second toothed orifice and the first toothed orifice; when the two pressers are pressed simultaneously, the two toothed columns remove from the second toothed orifice via the second toothed orifice and the first toothed orifice.
